(19) United States
(12) Patent Application Publication
(10) Pub. No.: US 2004/0051294 A1
(43) Pub. Date: Mar. 18, 2004

(54) Seat belt restraint system

(76) Inventor: Zhaoxia Xu, Ypsilanti, MI (US)

Correspondence Address: ZHAOXIA XU, 4694 SYCAMORE DR., YPSILANTI, MI, 48197, US

(21) Appl. No.: 10/242,194

(22) Filed: Sep. 12, 2002

(51) Int. Cl. B60R 22/00

(52) U.S. Cl. 280/801.1

(57) ABSTRACT

A seat belt restraint system for a vehicle occupant (18) seated in a vehicle seat (20), more specifically for a pregnant woman or a person who dislikes a lap belt (36) running right across his/her abdominal area. The seat belt restraint system includes a conventional three-point seat belt restraint system (28) and an attachment (43) adapted to provide one additional point of fixation on the seat belt webbing (34) and adapted to pull the middle portion of the lap belt (36) away from the occupant's abdominal area to the front portion of the vehicle seat (20).

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to vehicle occupant restraints. More specifically, this invention relates to seat belt restraint systems. Further more specifically, this invention relates to seat belt restraint systems for pregnant women or people who dislike a lap belt running across their abdominal area.

2. Prior Art

Vehicle occupant restraints, including seat belt devices and systems, are important and well-known components of vehicle safety systems. When a vehicle experiences severe impact, a properly belted-in occupant is held in place by the webbing, thereby avoiding many serious, if not fatal, physical collisions with vehicle interior and/or being thrown from the vehicle. Since their introduction seat belts have saved countless lives and reduced the severity of injury in countless more.

Initially seat belt restraint systems provided only a belt across the lap of the occupant. This is the so-called “two-point” seat belt restraint system. Although an improvement over no belt at all, such lap only seat belt restraint systems did nothing to restrain the very dangerous occupant's upper body motions. Therefore, head, neck and back injuries were very common among victims of vehicle collisions who were wearing only a lap belt.

An improvement to the two-point seat belt restraint system is the introduction of a third point of fixation. A second belt, shoulder belt, is provided. The upper end of the shoulder belt is extendable and retractable to the vehicle structure adjacent the occupant. This is the third point of fixation. The lower end of the shoulder belt extends to the lap belt via a sliding latch member. This latch member is engageable with a seat belt buckle on the inboard side of the occupant. These improved seat belt restraint systems are referred to as “three-point” seat belt restraint systems because they provide three fixation points for the webbing. Three-point seat belt restraint systems improve the performance of occupant restraint by restricting the occupant's upper body motions.

Many patents have been issued to three-point seat belt restraint systems. However, existing three-point seat belt restraint systems have an important drawback when used by pregnant women or people who dislike a lap belt running right across their abdominal area. They are uncomfortable to wear. Even worse, they are potentially dangerous for pregnant women and their unborn children if the vehicle is involved in a frontal crash accident.

Some patents have been issued in designing protective restraint systems for pregnant women.

U.S. Pat. No. 5,215,354, issued to Grene, on Jun. 1, 1993, describes a vehicle safety restraint for pregnant women, which includes a common element attached to a regular vehicle seat and two restraint members, one encompassing the upper torso region of the woman and the other one encompassing in the groin area thigh regions of the woman.

U.S. Pat. No. 4,610,463, issued to Efrom, on Sep. 9, 1986, describes a dome-like shield configured to overlie and at least partially surround the abdominal area thereby protecting the user against abnormal forces being delivered directly to the abdominal area.

The two above-discussed restraint systems can provide necessary restraint or protection for pregnant women. However, these systems are complicated and expensive to manufacture. On the other hand, they lack the convenience to use, thereby discouraging their application.

U.S. Pat. No. 5,624,136, issued to McGlothlin et al., on Apr. 29, 1997, describes a device for positioning and maintaining the lap belt in a downward direction on the pelvic bones of a pregnant woman. This device includes top, bottom, and seat members. A fastener connects the top member and the bottom member. The top member is looped around the lap belt. The bottom member is fastened on the underside of the vehicle's seat. The seat member is attached to the seat and straddles the bottom member holding the bottom member in easy access to the user.

Although the proposed device can position the lap belt in a downward direction thereby enhancing the comfort to use, it is an add-on attachment that lacks the potential of being integrated with the seat belt restraint system it modifies. Also, This device requires the occupant's two hands to buckle the top and bottom member together. The occupant also has to adjust the length of the device every time when she wears the seat belt restraint system. More important than all, as pointed out by its inventors, this device simply ensures that the seat belt remains where it is needed. It is not designed for strength like the seat belts.

U.S. Pat. No. 6,322,150, issued to Harper et al, on Nov. 27, 2001, describes a device for use by a pregnant woman. This device attaches to the lap belt portion of a vehicle seat belt restraint system. A cushion element is provided for increasing comfort and for urging the lap belt portion into proper position across the pelvis.

This device is primarily for comfort instead of for safety. The cushion element will provide very limited enhancement on the restraint performance since it is taking the occupant's abdominal surface curvature as a reaction surface.

Therefore, it remains desirable to provide a seat belt restraint system that is safer, more comfortable and convenient to use, and simpler and less expensive to manufacture, for pregnant women or people who dislike a lap belt running across their abdominal area.

### BRIEF SUMMARY OF THE INVENTION

Accordingly, the present invention is a seat belt restraint system having a conventional three-point seat belt restraint system and an attachment for use by a vehicle occupant, more specifically, by a pregnant woman or a person who dislikes a lap belt running right across his/her abdominal area. The attachment includes a seat belt buckle anchored to the vehicle and disposed at a convenient location on the front portion of the seat, a latch member having a webbing loop and a tongue plate engageable with the seat belt buckle, an extension belt with a first end attached to the webbing loop of the latch member and a second end leading to a connect plate. The connect plate interconnects the second end of the extension belt and the lap belt of the conventional three-point seat belt restraint system. The connect plate further includes a webbing loop, through which the lap belt is threaded, such that the connect plate is slidable along the lap belt. An open slot is provided on the webbing loop of the connect plate to allow the lap belt to slide in and out. Thus when no longer desired the connect plate can be easily removed from the seat belt restraint system.

Accordingly, several objects and advantages of the present invention are:

(a) to provide a seat belt restraint system for pregnant women or people who dislike a lap belt running across their abdominal area;

(b) to provide a seat belt restraint system for pregnant women to avoid fatal injuries to their unborn children if a frontal crash accident happens;

(c) to provide a seat belt restraint system which will present superior restraint performance and comfort for pregnant women or people who dislike a lap belt running across their abdominal area. General public can also make use of it with added restraint performance;

(d) to provide a seat belt restraint system which is easy and convenient to use for pregnant women or people who dislike a lap belt running across their abdominal area, thereby, encouraging its application.

Other objects and advantages are:

(a) to provide a seat belt restraint system which can be easily reconfigured to a regular seat belt restraint system. The proposed attachment can be an add-on device or part of a integrated seat belt restraint system;

(b) to provide a seat belt restraint system attachment which has minimum incremental weight increase; and

(c) to provide a seat belt restraint system attachment which is inexpensive to manufacture.

Further more features and advantages of the present invention will be readily appreciated as the same becomes better understood after reading the subsequent description when considered in connection with the accompanying drawings.

### BRIEF DESCRIPTION OF THE DRAWING—FIGURES

In the figures:

FIG. 1 illustrates an embodiment of the present invention.

FIG. 2 illustrates a plan view of the attachment in FIG. 1.

FIG. 3 illustrates an alternative installation of the second seat belt buckle on the seat.

FIG. 4 illustrates another alternative installation of the second seat belt buckle on the seat.

FIG. 5 illustrates an alternative embodiment of the present invention.

FIG. 6 illustrates a plan view of the attachment in FIG. 5.

FIG. 7 illustrates a further more alternative embodiment of the present invention.

### BRIEF DESCRIPTION OF THE DRAWING—REFERENCE NUMERALS

18 vehicle occupant

20 vehicle seat

22 seat back

24 seat portion

26 headrest

28 three-point seat belt restraint system

30 seat belt retractor

32 seat belt buckle

34 seat belt webbing

36 lap belt

38 shoulder belt

40 latch member

42 web guide

43 attachment

44 second seat belt buckle

46 second latch member

46a webbing loop

46b tongue plate

46c open slot

48 extension belt

50 connect plate

50a webbing loop

50b open slot

52 seat belt buckle sink

### DETAILED DESCRIPTION OF THE INVENTION

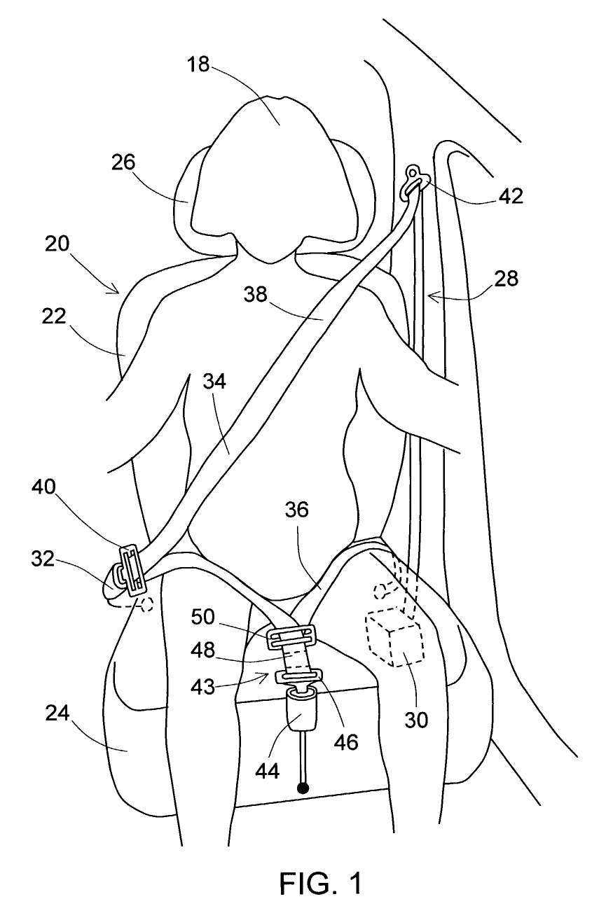

Reference is made to FIG. 1, which illustrates an embodiment of the present invention. As shown in FIG. 1, a vehicle occupant 18 is seated in a conventional vehicle seat 20. The vehicle seat 20 has a seat back 22, a seat portion 24, and a headrest 26. Also shown in FIG. 1 is a conventional three-point seat belt system 28, which, as seen below, is modified by the present invention.

The three-point seat belt restraint system 28 comprises a seat belt retractor 30, a seat belt buckle 32, a length of seat belt webbing, generally shown as 34, a latch member 40, and a web guide 42. The seat belt retractor 30 is secured to the vehicle structure. The seat belt buckle 32 is anchored to the vehicle seat 20 on the inboard side of the seated occupant 18. The seat belt webbing 34 is separated into a lap belt 36 and a shoulder belt 38 in a known manner. The latch member 40 has a webbing loop, through which the seat belt webbing 34 is threaded, and a tongue plate engageable with the seat belt buckle 32. The web guide 42 is secured to the vehicle structure adjacent the occupant 18.

The upper end of the shoulder belt 38 extends to the web guide 42 and further extends to the seat belt retractor 30. The other end of the shoulder belt 38 extends to one end of the lap belt 36 through the latch member 40. The other end of the lap belt 36 is anchored to the vehicle structure on the outboard side of the occupant 18. The lap belt 36 would typically run across the occupant's abdominal area. This deficiency is corrected by the present invention.

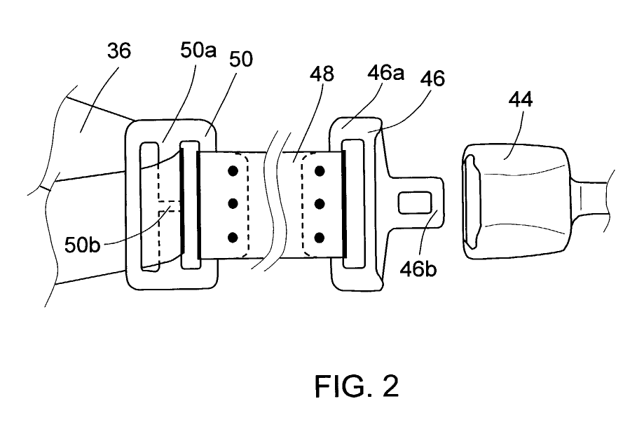

In the present invention, an attachment 43 is provided in modifying the conventional three-point seat belt restraint system 28. As shown in FIG. 1, the attachment 43 comprises a second seat belt buckle 44, a second latch member 46, an extension belt 48 and a connect plate 50. FIG. 2 illustrates a plan view of the attachment 43 in more details. The second seat belt buckle 44 is anchored to the vehicle structure on the front portion of the seat portion 24. The second latch member 46 has a webbing loop 46a, on which one end of the extension belt 48 is attached, and a tongue plate 46b engageable with the second seat belt buckle 44. The other end of the extension belt 48 extends to the connect plate 50. There is a webbing loop 50a on the connect plate 50, through which the lap belt 36 is threaded, such that the connect plate 50 is slidable along the lap belt 36. As shown in FIG. 2, the webbing loop 50a of the connect plate 50 has an open slot 50b to allow the lap belt 36 to slide in and out. Thus when no longer desired, the connect plate 50, together with the extension belt 48 and the second latch member 46, can be removed from the lap belt 36. Then the seat belt restraint system will function as a conventional three-point seat belt restraint system 28.

The open slot 50b on the connect plate 50 is specially designed to permit the lap belt 36 to slide in and out. Its width should be minimized to avoid excessive weakening of the webbing loop 50a and to avoid the lap belt 36 sliding out of the webbing loop 50a during an accident.

When the second latch member 46 is engaged with the second seat belt buckle 44, an additional fixation point is provided for the seat belt webbing 34. This additional fixation point pulls the middle portion of the lap belt 36 forward and downward to the front portion of the seat portion 24, away from occupant's abdominal area. Therefore, comfort with wearing this seat belt restraint system is apparent, for pregnant women or people who dislike a lap belt 36 running across their abdominal area. Also, this additional fixation point further improves the restraint performance of the three-point seat belt restraint system 28 because the occupant 18 is, now, more firmly restrained to the vehicle seat 20. General public can also make use of this seat belt restraint system with added restraint performance.

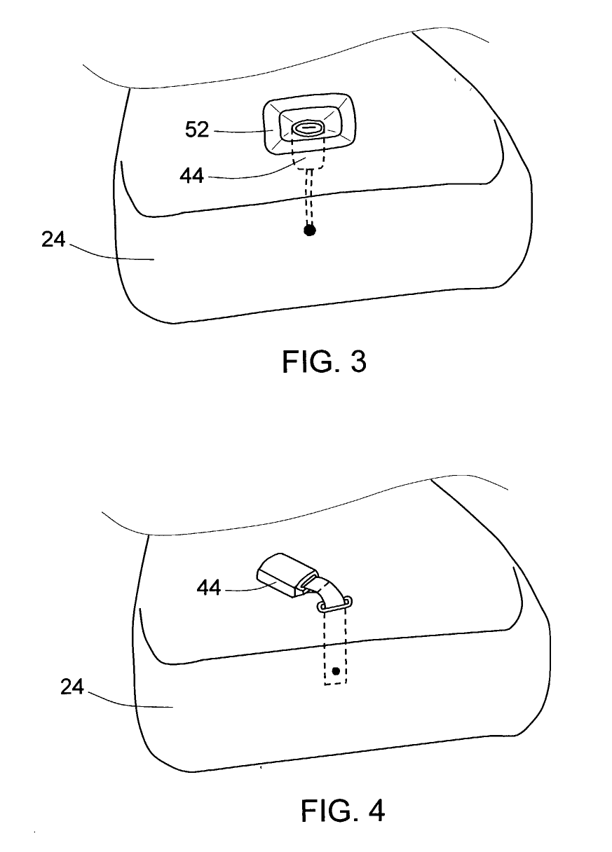

FIG. 3 illustrates an alternative installation of the second seat belt buckle 44 on the seat portion 24. The second seat belt buckle 44 can be alternatively anchored to the seat portion 24, imbedded into the cushion of the seat portion 24, such that the top portion of the latch member 46 will not sticking out of the cushion of the seat portion 24. This will avoid potential injuries to the occupant 18 if the occupant 18 slides forward in a frontal impact accident. A seat belt buckle sink 52 is provided on the seat cushion for the second seat belt buckle 44. A cover plate (not shown) can be provided, such that when the attachment 43 is no longer desired, the seat belt buckle sink 52 on the seat cushion can be covered up.

FIG. 4 illustrates another alternative installation of the second seat belt buckle 44 on the seat portion 24. The second seat belt buckle 44 can be alternatively anchored to the seat portion 24, using a length of belt webbing.

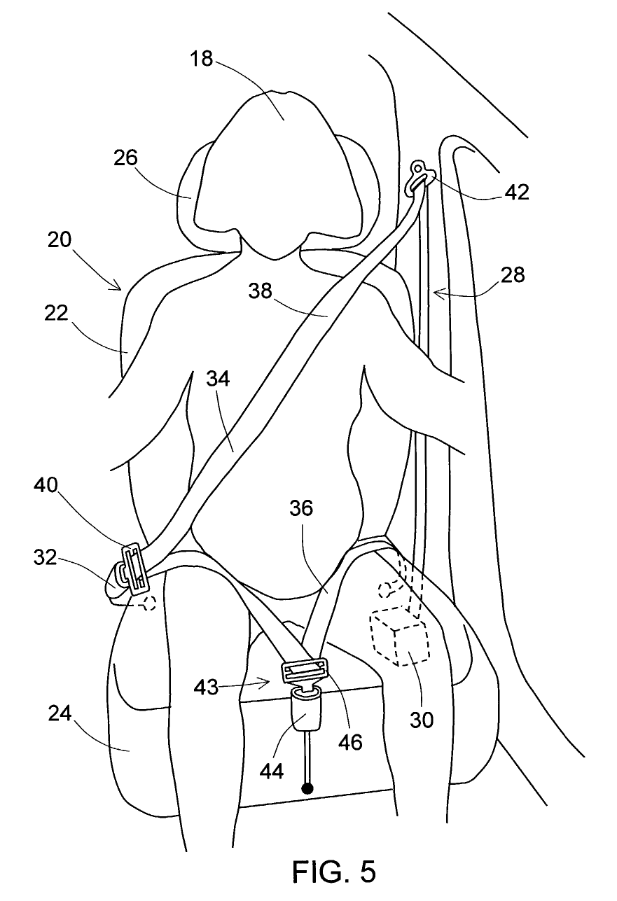

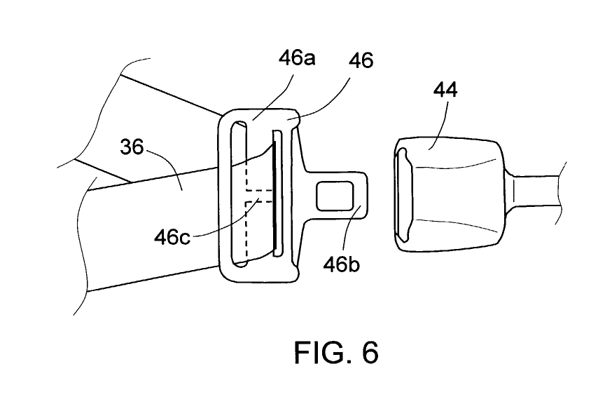

Reference is made to FIG. 5, which illustrates an alternative embodiment of the present invention. An attachment 43 is provided in modifying the conventional three-point seat belt restraint system 28. FIG. 6 illustrates a plan view of the attachment 43 in more details. The attachment 43 comprises a second seat belt buckle 44 and a second latch member 46. The second seat belt buckle 44 is anchored to the vehicle on the front portion of the seat portion 24. Alternative installations of the second seat belt buckle 44 on the seat portion 24 are referred to FIG. 3 and FIG. 4. The second latch member 46 has a webbing loop 46a, through which the lap belt 36 is threaded, such that the latch member 46 is slidable along the lap belt 36, and a tongue plate 46b engageable with the second seat belt buckle 44. Also as shown in FIG. 6, the webbing loop 46a of the latch member 46 has an open slot 46c to allow the lap belt 36 to slide in and out. Thus when no longer desired, the latch member 46 can be removed from the lap belt 36. Then the seat belt restraint system will function as a conventional three-point seat belt restraint system 28.

The open slot 46c on the webbing loop 46a is specially designed to permit the lap belt 36 to slide in and out. Its width should be minimized to avoid excessive weakening of the webbing loop 46a and to avoid the lap belt 36 sliding out of the webbing loop 46a during an accident.

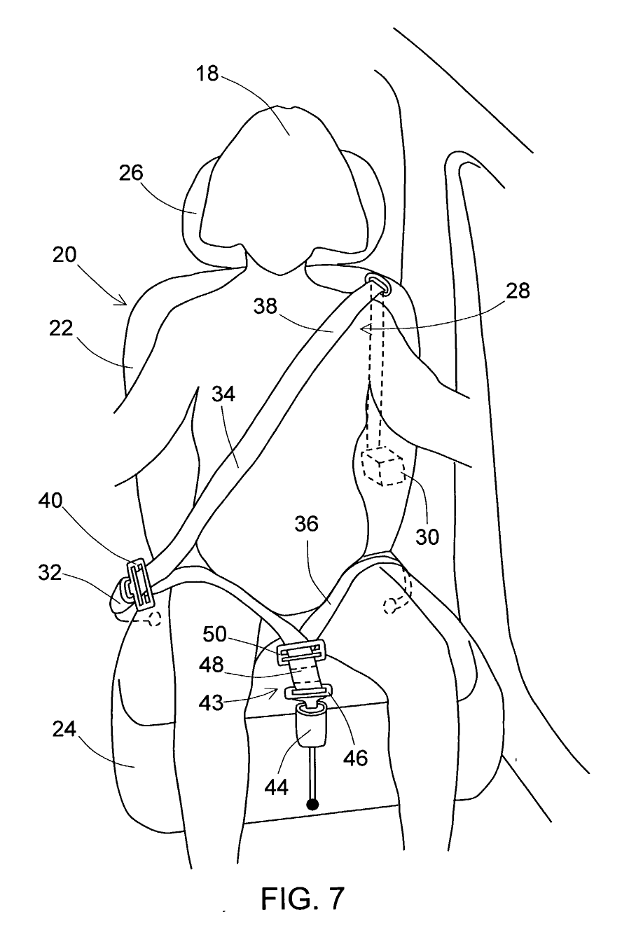

FIG. 7 illustrates a further more embodiment of the present invention, in which the conventional three-point seat belt restraint system 28 is seat mounted. The seat belt retractor 30 is mounted to the vehicle in the seat back 22. The upper end of the shoulder belt 38 extends to the upper portion of the seat back 22 adjacent the occupant's shoulder and further extends to the seat belt retractor 30. Alternative installations of the second seat belt buckle 44 on the seat portion 24 are referred to FIG. 3 and FIG. 4. Another variation of the attachment 43 is referred to FIG. 6. In operation, when the vehicle occupant 18 is seated in the vehicle seat 20, first, pull the first latch member 40 across the occupant's body with the inboard side hand. The second latch member 46 will present itself in front of the occupant's abdominal area. Second, insert the tongue plate of the second latch member 46 into the second seat belt buckle 44 with the outboard side hand. The lap belt 36 will wrap around the pelvic bone area of the occupant outboard leg. Finally, lock the tongue plate of the first latch member 40 into the first seat belt buckle 32. The lap belt 36 will further wrap around the pelvic bone area of the occupant inboard leg.

Accordingly, the reader will see that the seat belt restraint system of this invention can be used by pregnant women or people who dislike a lap belt running right across their abdominal area. It is comfortable and convenient to use thereby encouraging its application. General public can also make use of it. One additional fixation point is provided thereby resulting in added occupant restraint performance. The attachment 43 is simple and inexpensive to manufacture.

Although the invention has been described in its preferred forms and structures with a certain degree of particularity, these should not be construed as limiting the scope of the invention but as merely providing illustrations of some of the presently preferred embodiments of this invention. For example, since the attachment 43 is attached to the lap belt 36, it can, therefore, be used in conjunction with other forms of seat belt restraint systems, such as two-point and four-point seat belt restraint systems. The description of this invention also addresses specifically vehicle seat belt restraint systems. However, other modes of transportation, such as airplanes and rail trains, and other seats, such as wheel chairs, can also use this invention.

Thus it is understood that the present disclosure of the preferred forms can be changed in the details of construction and in the combination and arrangement of parts without departing from the spirit and the scope of the invention as hereinafter claimed.

What I claim as my invention is:

1. A seat belt restraint system attachment for a vehicle occupant seated in a vehicle seat, said seat belt restraint system attachment comprising:
a seat belt buckle anchored to the vehicle structure and disposed at a convenient location on the front portion of the vehicle seat;
a latch member having a webbing loop, through which the lap belt of the seat belt restraint system is threaded, such that said latch member is slidable along the lap belt, and an engagement means engageable with said seat belt buckle.

2. A seat belt restraint system attachment as defined in claim 1 wherein said latch member has an open slot of predetermined width on the webbing loop allowing the lap belt to slide in and out, whereby when no longer desired the latch member can be easily removed from the lap belt.

3. A seat belt restraint system attachment as defined in claim 1 wherein said engagement means of said latch member is a tongue plate engageable with said seat belt buckle.

4. A seat belt restraint system attachment for a vehicle occupant seated in a vehicle seat, said seat belt restraint system attachment comprising:
a seat belt buckle anchored to the vehicle and disposed at a convenient location on the front portion of the vehicle seat;
a latch member having an webbing loop and an engagement means engageable with said seat belt buckle;
an extension belt of predetermined length with a first end attached to said webbing loop of said latch member and a second end;
a connect means interconnecting said second end of said extension belt and the lap belt of the seat belt restraint system.

5. A seat belt restraint system attachment as defined in claim 4 wherein said engagement means of said latch member is a tongue plate engageable with said seat belt buckle.

6. A seat belt restraint system attachment as defined in claim 4 wherein said connect means has a webbing loop, through which the lap belt of the seat belt restraint system is threaded, such that said connect means is slidable along the lap belt.

7. A seat belt restraint system attachment as defined in claim 6 wherein said webbing loop of said connect means has an open slot of predetermined width to allow the lap belt to slide in and out, whereby when no longer desired said connect means, said extension belt, and said latch member can be easily removed from the lap belt.

8. A seat belt restraint system for a vehicle occupant seated in a vehicle seat, said seat belt restraint system comprising:
a shoulder belt with a first end adapted to be connected to the vehicle and adapted to be extended from an upper portion of vehicle structure adjacent the occupant and a second end;
a lap belt with a first end adapted to be continuously connected to said second end of said shoulder belt and a second end adapted to be anchored to the vehicle and disposed at a convenient location of the outboard side of the occupant;
a seat belt retractor associated with said shoulder belt for connecting said first end of said shoulder belt to the vehicle and adapted to be mounted to the vehicle at a convenient location;
a first seat belt buckle anchored to the vehicle and disposed at a convenient location on the inboard side of the occupant;
a second seat belt buckle anchored to the vehicle and disposed at a convenient location on the front portion of the vehicle seat;
a first latch member having a webbing loop, through which said lap belt is threaded, such that said first latch member is slidable along said lap belt, and a tongue plate engageable with said first seat belt buckle;
a second latch member having a webbing loop, through which said lap belt is threaded, such that said second latch member is slidable along said lap belt, and an engagement means engageable with said second seat belt buckle.

9. A seat belt restraint system as defined in claim 8 wherein said webbing loop of said second latch member has an open slot of predetermined width to allow said lap belt to slide in and out, whereby when no longer desired said second latch member can be easily removed from said lap belt.

10. A seat belt restraint system as defined in claim 8 wherein said engagement means of said second latch member is a tongue plate.
